(19) United States
(12) Patent Application Publication
(10) Pub. No.: US 2002/0078762 A1
(43) Pub. Date: Jun. 27, 2002

(54) Load sensor employing a crystal unit

(75) Inventors: Akio Chiba, Saitama (JP); Kozo Ono, Saitama (JP); Masami Yamanaka, Hyogo (JP); Motoyuki Adachi, Hyogo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: NIHON DEMPA KOGYO CO., LTD, Tokyo (JP)

(21) Appl. No.: 10/023,706

(22) Filed: Dec. 21, 2001

(30) Foreign Application Priority Data
Dec. 22, 2000 (JP) 2000-390393

(51) Int. Cl. G01L 5/00

(52) U.S. Cl. 73/862.41

(57) ABSTRACT

A load sensor measuring a load by a change in oscillation frequency of a crystal (quartz) blank due to stress sensibility against thereof when a load is applied to opposing outer circumferential portions of the crystal blank. In the sensor, the crystal blank is formed in a shape such that when the load is applied, any mechanical deformation in a direction perpendicular to the plane of the blank is prevented. For example, the crystal blank is constituted by two regions, a vibrating portion having a relatively small thickness and a protective frame portion having a relatively large thickness. Alternatively, in a planar blank, a groove is formed so as to extend along the outer circumference of the blank. In the rectangular blank, the frame portion or groove is preferably arranged along sides of the blank parallel with a direction in which the load is applied.

### BACKGROUND OF THE INVENTION

1. Field of the Invention

The present invention relates to a load sensor employing a crystal unit, and more particularly, relates to a load sensor capable of detecting a change in oscillation frequency due to the stress sensibility characteristic of a crystal unit.

2. Description of the Prior Art

A load sensor employing a piezoelectric vibrator such as a crystal unit (i.e., a quartz plate) is used for detecting a change in vibrating frequency of the piezoelectric vibrator in ppm (10⁻⁶) order, in response to a load applied thereto, and is adapted for being accommodated in a highly accurate load measuring instrument or a weighing scale. One typical example employing a crystal unit is a load sensor utilizing the stress sensibility characteristic of the crystal unit.

The prior art load sensor as shown in FIG. 1 includes a piece of crystal blank 1 severed into a piece of rectangular plate of quartz of, for example, an AT cutting. Crystal blank 1 has a thickness in the Y′-axis of its crystallographic axes (X, Y′, and Z′-axes), and chooses an axis inclining, for example, approximately 35 degrees from the Z-axis as a vertical direction in which a load is applied. Both major surfaces of crystal blank 1 have, formed thereon, excitation electrodes 2 from which leading electrodes 3 extend to the opposite ends of crystal blank 1. In FIG. 1, the excitation electrode and the leading electrode extending therefrom, which are formed on the major surface on the other side of the illustrated major surface section, are not seen. The pair of leading electrodes 3 on the major surfaces are connected to a non-illustrated oscillating circuit employing crystal blank 1 as a resonator element, by means of non-illustrated wiring.

In this load sensor, one end of the crystal blank 1 in the vertical direction is provided as a fixed end, and when a load is applied to the opposite end in the vertical direction, as shown in an arrow P, the vibration frequency or oscillation frequency of crystal blank 1 changes. This phenomenon is known as the stress sensibility characteristic, and as shown in FIG. 2, for example, the vibration frequency increases in proportion to the applied load. Therefore, from a change in the oscillation frequency of a signal out by the oscillating circuit, it is possible to measure the extent of the load. At this stage, the above-mentioned one end of crystal blank 1 is formed as the fixing end at which crystal blank 1 is fixed to holding pedestal 4. Here, since the direction in which the load is applied is set to an axial direction inclined approximately 35 degrees from the crystallographic Z-axis of the quartz crystal, any change in the oscillation frequency due to a temperature change can be prevented.

Nevertheless, in the load sensor of the above-described construction, crystal blank 1 is mechanically deformed in a direction vertical to the plane of the crystal blank, as shown in FIG. 3, and causes a bend in the vertical direction of crystal blank 1. The mechanical deformation such as the above-mentioned bend causes a change in the oscillation frequency. Therefore, in the prior art load sensor, since the change in the oscillation frequency caused by the mechanical bend is superposed onto the change in the oscillation frequency due to the load in the vertical direction, such a problem occurs that the accuracy in the measurement might be reduced.

### SUMMARY OF THE INVENTION

An object of the present invention is to provide a highly accurate load sensor capable of detecting a change in the oscillation frequency due to only a load by preventing any mechanical deformation of a crystal blank in a direction perpendicular to the plane of the crystal blank.

The object of the present invention is attained by the employment of a crystal blank of which the shape is formed such that when a load is applied to between opposing outer circumferential portions of the crystal blank, mechanical deformation in a direction perpendicular to a plane of the plate can be prevented.

More concretely, the crystal blank is constituted by two regions, i.e., one being a vibrating portion that is relatively small in thickness thereof and the other being a protective frame portion that is relatively large in thickness. The protective frame portion is preferably provided along the outer circumference of the vibrating portion. In a case of the rectangular crystal blank, the protective frame portion is preferably formed along the sides parallel with a direction in which the load is applied.

Alternatively, in a crystal blank of a planar plate, a groove may be formed along an outer circumference of the crystal blank. In a case where rectangular crystal blank is used, the groove is preferably arranged at least along a side perpendicular to a direction in which a load is applied.

In accordance with a load sensor of the present invention having the above-described constitution, either strength against an applied load can be maintained or a force component in an unnecessary direction may be absorbed, so that any change in the oscillation frequency due to a mechanical deformation in a direction perpendicular to the plane of the crystal blank can be eliminated. In accordance with the present invention, a load sensor capable of detecting a change in the oscillation frequency due to only a load, and accordingly, the load sensor can be a highly accurate load sensor.

### BRIEF DESCRIPTION OF THE DRAWINGS:

FIG. 1 is a schematic perspective view of a load sensor according to the prior art;

FIG. 2 is a frequency characteristic diagram indicating a oscillation frequency against a load;

FIG. 3 is a side view of the load sensor of the prior art, illustrating a mechanical deformation;

FIG. 4 is a schematic perspective view of a load sensor according to a preferred embodiment of the present invention;

FIG. 5 is a cross-sectional view of the load sensor shown in FIG. 4;

FIG. 6 is a plan view of the load sensor (the crystal blank);

FIG. 7 is a plan view of a load sensor (a crystal blank) according to another embodiment of the present invention;

FIG. 8 is a plan view of a load sensor (a crystal blank) according to a further embodiment of the present invention; and

FIG. 9 is a cross-sectional view of the load sensor shown in FIG. 8.

### DETAILED DESCRIPTION OF THE PREFERRED EMBODIMENTS

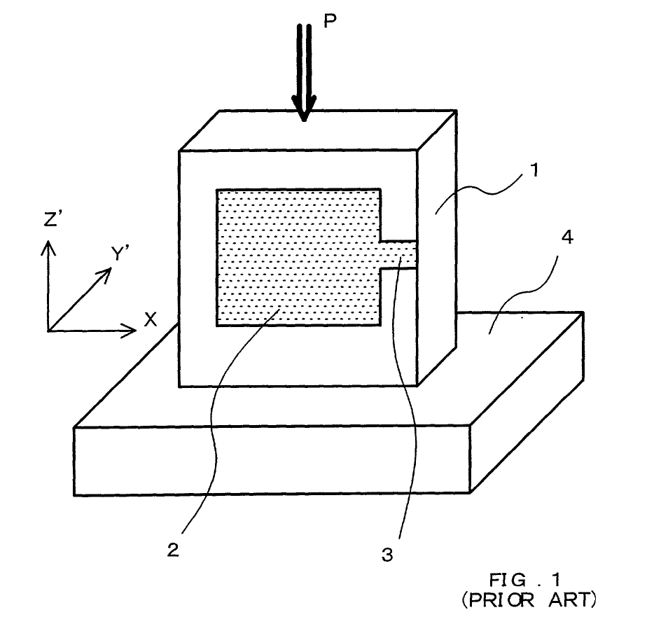

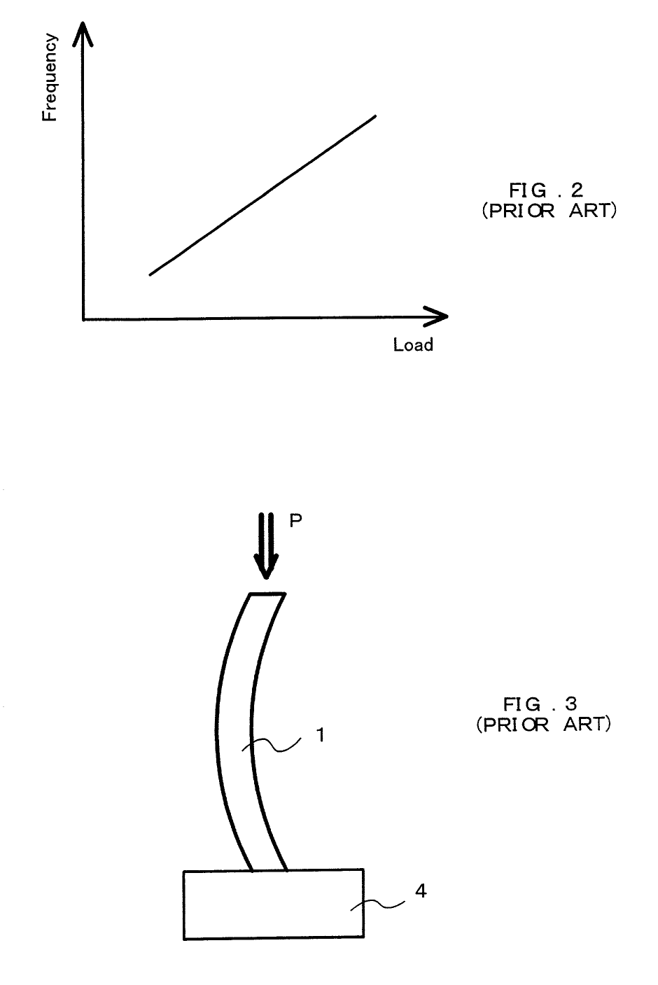

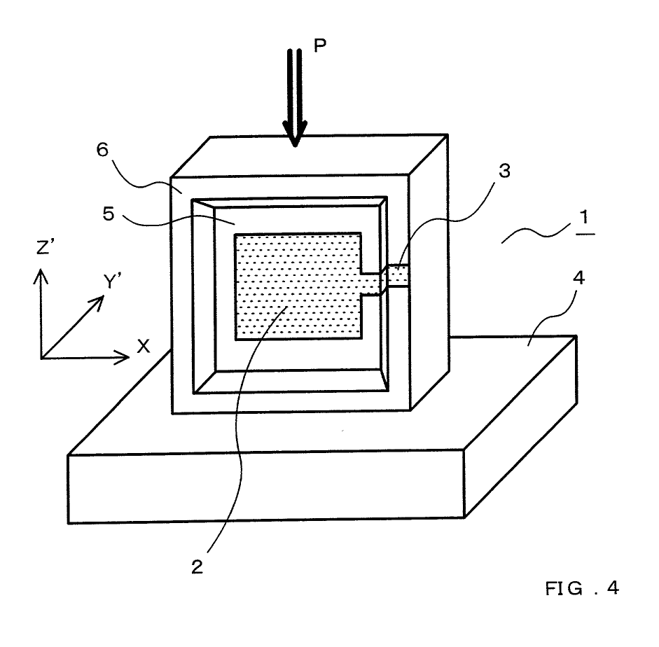

In a load sensor according to a preferred embodiment of the present invention, as illustrated in FIG. 4, all constituents the same as or identical to those illustrated in FIG. 1 are designated by the same reference numerals and description thereof will be omitted hereinafter for the sake of avoiding repetition.

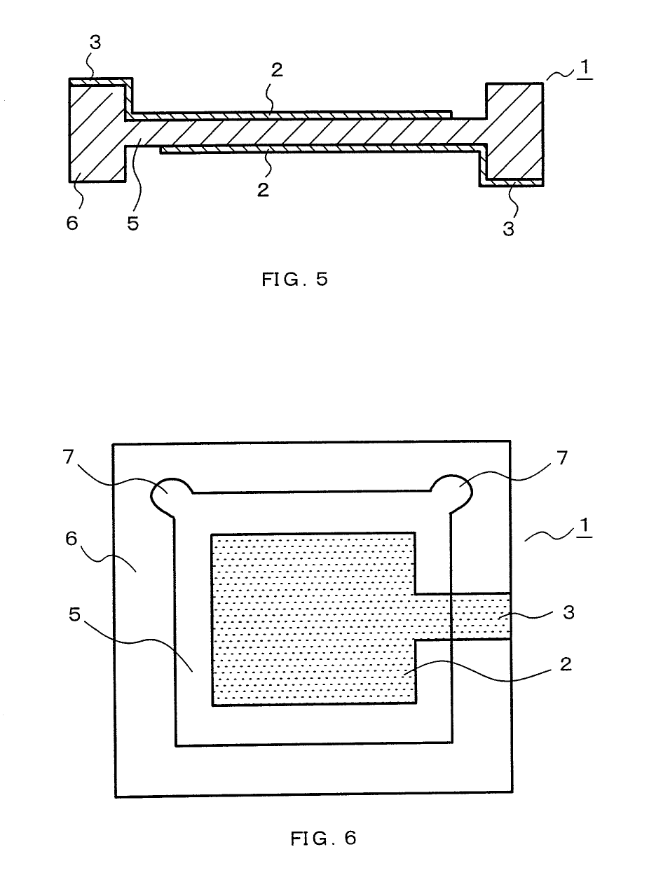

The load sensor shown in FIG. 4 is provided with crystal blank 1 severed by the AT cutting. When the crystallographic axes of this crystal blank 1 are represented by (X, Y′, and Z′-axes), the crystal blank has its thickness in the direction of the Y′-axis, and is shaped in a rectangle having an axis thereof inclined 35 degrees from the Z-axis as the axis corresponding to a vertical direction. In the present embodiment, crystal blank 1 is provided with major surfaces, each of which is formed with a recessed portion. Namely, crystal blank 1 is constituted by vibrating portion 5 that is small in its thickness, and protective frame portion 6 arranged along the outer circumference of vibrating portion 5 and being large in thickness. In both major surface, the width of protective frame portion 6 along the entire part of the outer circumference thereof is made equal. FIG. 5 illustrates the shape of a cross-section of crystal blank sectioned horizontally at a central portion in the vertical direction.

In vibrating portion 5, both major surfaces of crystal blank 1 are respectively formed with excitation electrode 2. Leading electrodes 3 horizontally extend respectively from both exciting electrodes 2 toward the opposite end portions of crystal blank 1 until they arrive at protective frame portion 6. This pair of leading electrodes 3 is electrically connected to a non-illustrated oscillating circuit provided with this crystal blank 1 as its resonator element, by means of non-illustrated wirings. Further, a holding pedestal 4 is arranged so that a lower end side of crystal blank 1 shown in FIG. 4 is provided for forming a fixed end to fix the crystal blank to holding pedestal 4.

In the load sensor having the above-described constitution, when the protective frame portion on the upper side in the vertical direction of crystal blank 1 is subjected to a load P in a downward direction as shown by an arrow, the extent of the load P can be measured by detecting a change in the oscillation frequency of the oscillating circuit in response to application of the load P.

In the above-constituted load sensor, a change in the oscillation frequency of crystal blank 1, which is caused by a stress given to vibrating portion 5, allows to detect a load, and in addition, the mechanical strength of protective frame portion 6 allows to prevent vibrating portion 5 from being mechanically deformed in a direction perpendicular to the plane of vibrating portion 5 under the application of the load to the crystal blank. In other words, vibrating portion 5 is subjected to only a load in the vertical direction. Accordingly, in this load sensor, since a change in the oscillation frequency caused by only a load is detected, accuracy in the detection or measurement of a load can be appreciably enhanced.

The load sensor according to the present invention is not limited to one having the above-described constitution.

A load sensor shown in FIG. 6 has a constitution substantially identical with that of the load sensor shown in FIG. 4. However, this load sensor shown in FIG. 6 is different in that, in four inner corners of protective frame portion 6, which are provided for every one of major surfaces of crystal blank 1, the illustrated two upper corners are provided with arcuate recesses 7, respectively, and at the respective portions of arcuate recesses 7, the crystal blank has the thickness thereof identical with that of vibrating portion 5. Namely, at the two portions in which arcuate recesses 7 are formed, protective frame portion 6 is engraved. Although not illustrated in FIG. 6, this crystal blank 1 is also fixed to a holding pedestal at the illustrated lower end side formed as a fixed end, so that a load is vertically applied to the upper end side. In this case, provision of arcuate recesses 7 permits it to reduce a load effectively applied to protective frame portion 6 whereby application of the load is concentrated to vibrating portion 5. Thus, a deformation of crystal blank 1 in the vertical direction against load P becomes larger while enhancing the sensibility of the load sensor. The positions of arcuate recesses 7 are not limited to the illustrated two inner corners on the upper side, and recesses may be formed at the positions of the illustrated two inner corners on lower side. Alternatively, all of the four inner corners may be formed with a recess, respectively.

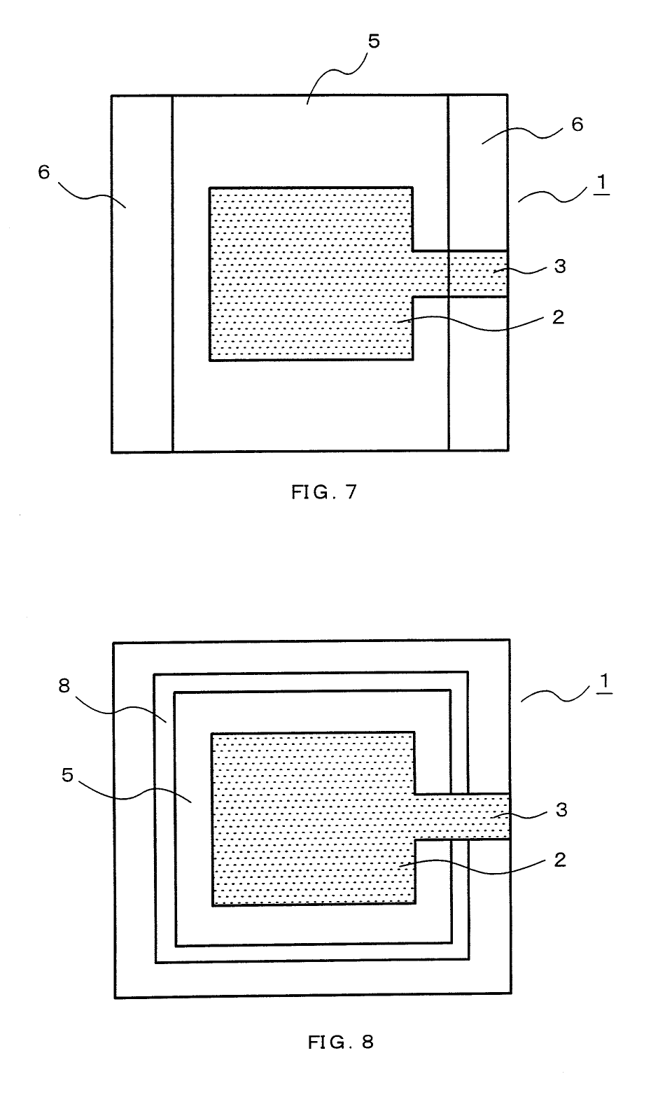

Further, as illustrated in FIG. 7, a part of protective frame portion 6, i.e., the part located on the upper and lower sides of crystal blank 1 may be removed from the constitution shown in FIG. 4. In other words, only the two sides of crystal blank 1 parallel with the direction in which a load is applied may be provided with protective frame portion 6. Although not illustrated in FIG. 7, this crystal blank 1 is again fixed to a holding pedestal at the illustrated lower end side thereof formed as a fixed end, and a load is vertically applied to the crystal blank from the illustrated upper end side. In this load sensor, two separate protective frame portions 6 extending in parallel with the direction in which the load is applied contribute to increasing of the strength of crystal blank 1 while permitting only a vertical load to be applied to vibrating portion 5. Thus, the sensibility and accuracy of the load sensor can be enhanced. In the sensor illustrated in FIG. 7, although protective frame portions 6 are formed on the two sides of crystal blank 1, which are parallel with the direction in which load P is applied, only one of these two sides might be formed with protective frame portion 6 for the purpose of increasing the strength of the crystal blank and of enhancing the sensibility and accuracy. Selection of an arrangement from either a case where both sides extending in a vertical direction are respectively formed with protective frame portion 6 or the other case where only one of the two sides is formed with protective frame portion 6 may be made as required by taking into consideration, for example, the width of protective portion 6.

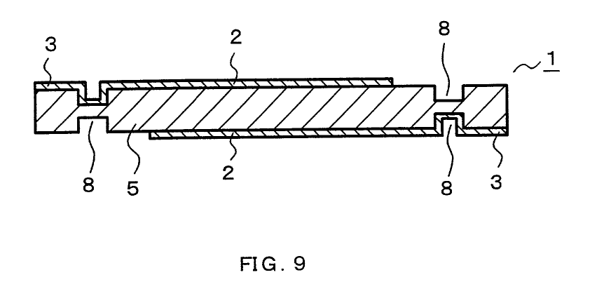

Further, instead of constituting crystal blank 1 by vibrating portion 5 small in its thickness and protecting frame portion 6 large in its thickness and arranged around vibrating portion 5, rectangular crystal blank 1 per se may be formed, as shown in FIG. 8, in a flat plate member having opposite faces respectively each forming a major surface in which groove 8 is formed so as to rectangularly run in a region slightly inside the outermost edge of crystal blank 1. FIG. 9 illustrates a cross-section of crystal blank 1 having the above-described constitution in a case where the crystal blank is sectioned at a central position of the vertical direction in a horizontal direction, which is perpendicular to the vertical direction. A rectangular region encircled by groove 8 defines vibrating portion 5 in which excitation electrode 2 is provided on each of the opposite faces of the crystal blank. From these excitation electrodes 2 on both faces of the crystal blank leading electrodes 3 extend laterally beyond respective grooves 8 to the outermost edges of crystal blank 1. Although not illustrated in FIG. 8, this crystal blank 1 is fixed at its lower end side to a holding pedestal, so that a load is applied vertically thereto from the upper end side.

In the described crystal blank 1, since grooves 8 are arranged in the outer region on each of both faces of the crystal blank, stress acting on crystal blank 1 in a direction perpendicular to the plane of the crystal blank can be absorbed by grooves 8, and accordingly mechanical deformation of vibrating portion 5 can be prevented. Thus, a change in the oscillation frequency due to only an applied load can be detected. Namely, accuracy in the measurement of a load can be increased. At this stage, it should be understood that an arrangement of the grooves is not limited to that of the above-described embodiment, and various arrangements of the grooves may be employed if the employed arrangement of grooves were able to prevent occurrence of mechanical deformation in a direction perpendicular to the plane of crystal blank 1, especially a bend in the vertical direction, when a load is vertically applied to the crystal blank. For example, a linearly running groove may be arranged in a region extending along only the illustrated upper side of each of both faces of crystal blank 1. Alternatively, a circularly running groove may be arranged so as to define a circular region inside the groove, which forms vibrating portion.

While the load sensor according to the present invention have been described using specific terms, the present invention is not limited to the above-described embodiments. Changes and variations of the present invention may be made without departing from the spirit or scope of the following claims.

What is claimed is:

1. A load sensor including a crystal blank, and detecting a load by a change in oscillation frequency of said crystal blank when the load is applied to opposing outer circumferential portions of said crystal blank, characterized in that:
said crystal blank is formed to have such a shape that mechanical deformation of said crystal blank in a direction perpendicular to a plane of said crystal blank due to the application of said load to said outer circumferential portions is prevented.

2. A load sensor comprising a crystal blank, and detecting a load by a change in oscillation frequency of said crystal blank when the load is applied to opposing outer circumferential portions of said crystal blank,
said crystal blank comprising a vibrating portion relatively small in its thickness, and a protective frame portion relatively large in its thickness.

3. A load sensor according to claim 2, wherein said vibrating portion is provided with excitation electrodes on respective of both major surfaces of said crystal blank.

4. A load sensor according to claim 2, wherein said crystal blank has a substantially rectangular shape, and wherein said protective frame portion is formed to extend along whole of the outer circumference of said crystal blank.

5. A load sensor according to claim 2, wherein said crystal blank has a substantially rectangular shape, and wherein said protective frame portion is formed to extend along at least one of sides of said rectangular crystal blank which are parallel with a direction in which said load is applied.

6. A load sensor according to claim 4, wherein a recess is formed in said protective frame portion at an inner corner thereof by engraving said protective frame portion.

7. A load sensor according to claim 6, wherein said recess is formed at each of positions corresponding to both ends of one side of said crystal blank, which extends perpendicularly to a direction in which said load is applied.

8. A load sensor comprising a crystal blank, and detecting a load by a change in oscillation frequency of said crystal blank when the load is applied to opposing outer circumferential portions of said crystal blank, characterized in that said crystal blank is formed in a planar plate shape, and is provided with a groove formed therein, which extends along the outer circumference of said crystal blank.

9. A load sensor according to claim 8, wherein said crystal blank has a substantially rectangular shape, and wherein said groove is formed to extend along whole of outer circumference of said crystal blank.

10. A load sensor according to claim 9, wherein in a region encircled by said groove, said crystal blank is formed with excitation electrodes on both major surfaces thereof.

11. A load sensor according to claim 8, wherein said crystal blank has a substantially rectangular shape, and wherein said groove is formed to extend along a side perpendicular to a direction in which said load is applied.
